(19) United States
(12) Patent Application Publication
(10) Pub. No.: US 2006/0013448 A1
(43) Pub. Date: Jan. 19, 2006

(54) Biometric data collating apparatus, biometric data collating method and biometric data collating program product

(75) Inventors: Yasufumi Itoh, Tenri-Shi (JP); Manabu Yumoto, Nara-Shi (JP); Manabu Onozaki, Nara-Shi (JP); Masayuki Ehiro, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka (JP)

(21) Appl. No.: 11/169,793

(22) Filed: Jun. 30, 2005

(30) Foreign Application Priority Data
Jul. 2, 2004 (JP) 2004-197081(P)

(51) Int. Cl. G06K 9/00

(52) U.S. Cl. 382/115

(57) ABSTRACT

In a biometric data collating apparatus according to the invention, when a reference data matching with a biometric data is present, each of collation order determination values is multiplied by a FREQFIX value. One is further added to the collation order determination value corresponding to the reference data matching with the biometric data. A comparison is made between the updated data, and the reference data are sorted in a descending order of the collation order determination value.

This nonprovisional application is based on Japanese Patent Application No. 2004-197081 filed with the Japan Patent Office on Jul. 2, 2004, the entire contents of which are hereby incorporated by reference.

### BACKGROUND OF THE INVENTION

1. Field of the Invention

The present invention relates to a biometric data collating apparatus, a biometric data collating method and a biometric data collating program product, and particularly to a biometric data collating apparatus, a biometric data collating method and a biometric data collating program product which collates a collation target data formed of biometric information such as fingerprints with a plurality of collation data (i.e., data for collation).

2. Description of the Background Art

As a biometric data collating apparatus employing a biometrics technology, Japanese Patent Laying-Open No. 2003-323618 has disclosed such a biometric data collating apparatus that collates data of biometric information such as fingerprints provided thereto with collation data registered in advance for authenticating personal identification.

Further, the biometric data collating apparatus used by a plurality of users for management of entry/exit of people successively collates input data with a plurality of registered collation data, and determines whether the input data matches with any one of the collation data or not.

However, the conventional biometric data collating apparatus collates the collation target data provided thereto with the plurality of collation data by reading and using the collation data in an order fixed in advance, and cannot dynamically change the collation order for reducing a quantity or volume of processing. This results in problems that a processing quantity required for collation is large on average, and increases in proportion to the number of the registered collation data. Further, the large processing quantity results in a problem that the collation requires a long processing time and large power consumption.

### SUMMARY OF THE INVENTION

An object of the invention is to reduce a processing quantity required for collating the input collation target data.

The above object of the invention can be achieved by a biometric data collating apparatus including the following components. Thus, the biometric data collating apparatus includes a collation target data input unit receiving biometric collation target data; a collation data storing unit storing a plurality of collation data used for collating the collation target data received by the collation target data input unit and priority values representing degrees of priority of collation for the respective collation data; a collating unit reading each of the collation data stored in the collation data storing unit in a descending order of the priority value, and collating the read collation data with the collation target data received by the collation target data input unit; and a priority value updating unit updating the priority value corresponding to the collation data based on a result of the collation by the collating unit. The priority value updating unit updates the priority values such that the priority value corresponding to the collation data determined as matching data by the collating unit at a later time takes a larger value.

Preferably, the priority value updating unit updates the priority value by performing arithmetic of (A·D (where 0<A<1)+B (where B>0)) on a priority value D corresponding to the collation data determined as matching data by the determining unit, and updates the priority value by performing by performing arithmetic of (A·D) using the A on the priority value D corresponding to the collation data determined as mismatching data by the collating unit.

Preferably, the collation data storing unit includes a plurality of priority value tables including a first priority value table formed of the priority values respectively and individually corresponding to the plurality of collation data, and a second priority value table formed of the priority values respectively and individually corresponding to the plurality of collation data, and the biometric data collating apparatus further includes a selecting unit selecting the priority value table defining the priority value used by the collating unit from the plurality of priority value tables stored by the collation data storing unit.

Preferably, the collation data storing unit stores a plurality of priority value tables classified according to predetermined collation times, and the biometric data collating apparatus further includes a determining unit determining the collation time of the collation unit. The selecting unit selects the priority value table corresponding to the collation time determined by the determining unit. The collating unit performs the collation using the priority value table selected by the selecting unit. The priority value updating unit updates the priority value in the priority value table selected by the selecting unit based on the collation result of the collating unit.

Preferably, the collation data storing unit stores a plurality of priority value tables classified according to input places of the collation target data. The selecting unit selects the priority value table corresponding to the input place of the collation target data input to the collation data input unit. The collating unit performs collation using the priority value table selected by the selecting unit. The priority value updating unit updates the priority values in the priority value table selected by the selecting unit based on the collation result of the collating unit.

Preferably, the collation data storing unit stores two priority value tables classified for an entry place and an exit place, respectively. When the collation target data is input from the entry place into the collation data input unit, the selecting unit selects the priority value table for the entry place for the collation by the collating unit, and selects the priority value table for the exit place for updating by the priority value updating unit, the collating unit performs the collation using the priority value table for the entry place selected by the selecting unit, and the priority value updating unit updates the priority value in the priority value table for the exit place selected by the selecting unit based on the collation result of the collating unit. When the collation target data is input from the exit place into the collation data input unit, the selecting unit selects the priority value table for the exit place for the collation by the collating unit, and selects the priority value table for the entry place for the updating by the priority value updating unit, the collating unit performs the collation using the priority value table for the exit place selected by the selecting unit, and the priority value updating unit updates the priority value of the priority value table for the entry place selected by the selecting unit based on the collation result of the collating unit.

According to another aspect of the invention, a biometric data collating method includes a collation target data input step of receiving biometric collation target data; a collating step of reading, in a descending order of a priority value of a collation data, the collation data from a collation data storing unit storing the plurality of collation data used for collating the collation target data received in the collation target data input step and the priority values representing degrees of priority of collation for the respective collation data, and collating the read collation data with the collation target data received in the collation target data input step; and a priority value updating step of updating the priority value corresponding to the collation data based on a result of the collation in the collating step, and updating the priority value corresponding to the collation data such that the priority value corresponding to the collation data determined as matching data in the collating step at a later time takes a larger value.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a structure of a biometric information collating apparatus.

FIG. 2 shows a configuration of a computer provided with the biometric information collating apparatus.

FIG. 3 is a flowchart illustrating collation processing 1.

FIG. 4 is a flowchart illustrating collation determination processing.

FIG. 5 is a process flowchart of template matching and calculation of a similarity score.

FIG. 6 is a flowchart illustrating collation order updating processing.

FIGS. 7A, 7B and 7C illustrate a collation order table.

FIG. 8 is a block diagram of a biometric information collating apparatus of a second embodiment.

FIG. 9 is a flowchart illustrating collation processing 2 of the second embodiment.

FIG. 10 is a flowchart illustrating collation processing 3 of a third embodiment.

FIGS. 11A and 11B illustrate relationships between a collation time and a collation table.

FIG. 12 illustrates a relationship of the data input units respectively arranged in different places with respect to display numbers of the collation order table and collation order determination tables.

FIG. 13 is a flowchart illustrating collation processing 4 of a fourth embodiment.

FIG. 14 is a flowchart illustrating collation processing 5 of a fifth embodiment.

FIG. 15 illustrates a relationship of the data input units respectively arranged corresponding to an entrance and an exit with respect to the table numbers of the collation tables used for collation determination and updating.

### DESCRIPTION OF THE PREFERRED EMBODIMENTS

Embodiments of the invention will now be described with reference to the drawings. A biometric information collating apparatus 1 receives biometric information data, and collates it with reference data (i.e., data for reference) which is registered in advance. Fingerprint image data will be described by way of example as collation target data, i.e., data to be collated. However, the data is not restricted to it, and may be another image data, voice data or the like representing another biometric feature which is similar to those of other individuals or persons, but never matches with them. Also, it may be image data of the striation or image data other than the striation. In the figures, the same or corresponding portions bear the same reference numbers, and description thereof is not repeated.

### First Embodiment

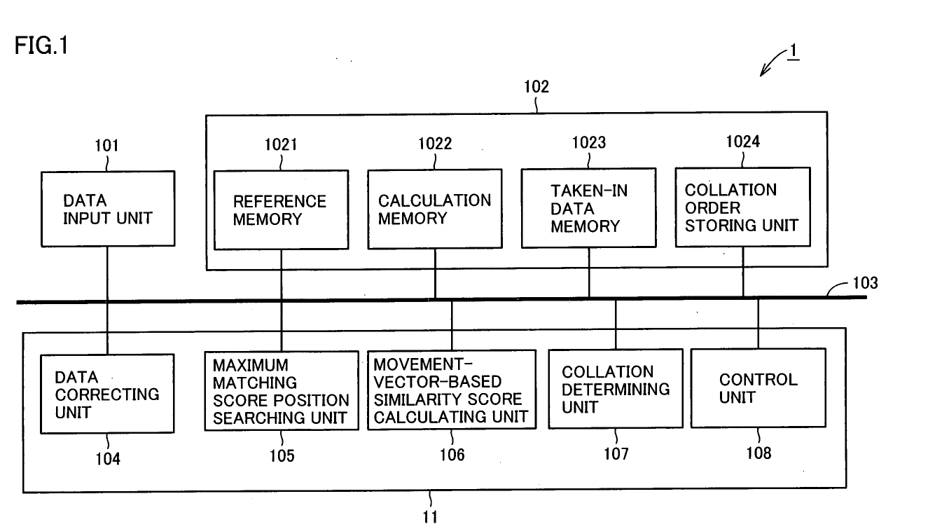

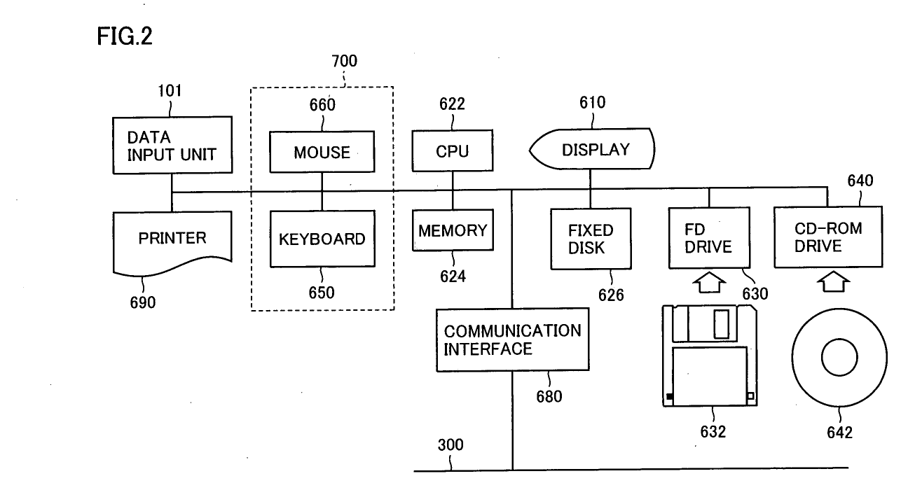

FIG. 1 is a block diagram of biometric information collating apparatus 1 according to a first embodiment. FIG. 2 shows a configuration of a computer provided with biometric information collating apparatus 1 according to each of embodiments.

Referring to FIG. 2, the computer includes a data input unit 101, a display 610 such as a CRT (Cathode Ray Tube) or a liquid crystal display, a CPU (Central Processing Unit) 622 for central management and control of the computer itself, a memory 624 including an ROM (Read Only Memory) or an RAM (Random Access Memory), a fixed disk 626, an FD drive 630 on which an FD (flexible disk) 632 is detachably mounted and which accesses to FD 632 mounted thereon, a CD-ROM drive 640 on which a CD-ROM (Compact Disc Read Only Memory) is detachably mounted and which accesses to mounted CD-ROM 642, a communication interface 680 for connecting the computer to a communication network 300 for establishing communication, a printer 690, and an input unit 700 having a keyboard 650 and a mouse 660. These components are connected through a bus for communication.

The computer may be provided with a magnetic tape apparatus accessing to a cassette type magnetic tape that is detachably mounted thereto.

Referring to FIG. 1, biometric information collating apparatus 1 includes data input unit 101, memory 102 that corresponds to a memory 624 or a fixed disk 626 shown in FIG. 2, a bus 103 and a collation processing unit 11. Memory 102 stores data (image in this embodiment) and various calculation results. Collation processing unit 11 includes a data correcting unit 104, a maximum matching score position searching unit 105, a unit 106 calculating a similarity score based on a movement vector (which will be referred to as a “movement-vector-based similarity score calculating unit” hereinafter), a collation determining unit 107 and a control unit 108. Functions of these units in collation processing unit 11 are realized when corresponding programs are executed.

Data input unit 101 includes a fingerprint sensor, and outputs a fingerprint image data that corresponds to the fingerprint read by the sensor. The sensor may be an optical, a pressure-type, a static capacitance type or any other type sensor.

Memory 102 includes a reference memory 1021 (i.e., memory for reference) storing data used for collation with the fingerprint image data applied to data input unit 101, a calculation memory 1022 temporarily calculating various calculation results, a taken-in data memory 1023 taking in the fingerprint image data applied to data input unit 101, and a collation order storing unit 1024 (i.e., memory for storing a collation order).

Collation processing unit 11 refers to each of the plurality of collation data (i.e., data for collation) stored in reference memory 1021, and determines whether the collation data matches with the fingerprint image data received by data input unit 101 or not. In the following description, the collation data stored in reference memory 1021 will be referred to as “reference data” hereinafter.

Collation order storing unit 1024 stores a collation order table including indexes of the reference data as elements. Biometric information collating apparatus 1 reads the reference data from reference memory 1021 in the order of storage in the collation order table, and collates them with the input fingerprint image data.

Bus 103 is used for transferring control signals and data signals between the units. Data correcting unit 104 performs correction (density correction) on data (i.e., fingerprint image in this embodiment) applied from data input unit 101. Maximum matching score position searching unit 105 uses a plurality of partial areas of one data (fingerprint image) as templates, and searches for a position of the other data (fingerprint image) that attains the highest matching score with respect to the templates. Namely, this unit serves as a so-called template matching unit.

Using the information of the result of processing by maximum matching score position searching unit 105 stored in memory 102, movement-vector-based similarity score calculating unit 106 calculates the movement-vector-based similarity score. Collation determining unit 107 determines a match/mismatch, based on the similarity score calculated by movement-vector-based similarity score calculating unit 106. Control unit 108 controls processes performed by various units of collation processing unit 11.

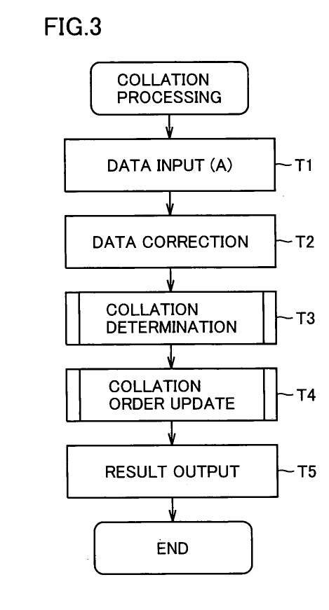

Referring to FIG. 3, description will now be given on the procedures of collating the data (fingerprint image) applied from data input unit 101 with the reference data (fingerprint image) by biometric information collating apparatus 1. FIG. 3 is a flowchart illustrating collation processing 1 of collating the input data with the reference data.

First, data input processing is executed (step T1). In the data input processing, control unit 108 transmits a data input start signal to data input unit 101, and thereafter waits for reception of a data input end signal. Data input unit 101 receiving the data input start signal takes in collation target data A for collation, and stores collation target data A at a prescribed address of taken-in data memory 1023 through bus 103. Further, after the input or take-in of collation target data A is completed, data input unit 101 transmits the data input end signal to control unit 108.

Then, the data correction processing is executed (step T2). In the data correction processing, control unit 108 transmits a data correction start signal to data correcting unit 104, and thereafter, waits for reception of a data correction end signal. In most cases, the input image has uneven image quality, as tones of pixels and overall density distribution vary because of variations in characteristics of data input unit 101, dryness of fingerprints and pressure with which fingers are pressed. Therefore, it is not appropriate to use the input image data directly for collation.

Data correcting unit 104 corrects the image quality of input image to suppress variations of conditions when the image is input (step T2). Specifically, for the overall image corresponding to the input image or small areas obtained by dividing the image, histogram planarization, as described in Computer GAZOU SHORI NYUMON (Introduction to computer image processing), SOKEN SHUPPAN, p. 98, or image thresholding (binarization), as described in Computer GAZOU SHORI NYUMON (Introduction to computer image processing), SOKEN SHUPPAN, pp. 66-69, is performed on collation target data A stored in taken-in data memory 1023. After the end of data correction processing of collation target data A, data correcting unit 104 transmits the data correction end signal to control unit 108.

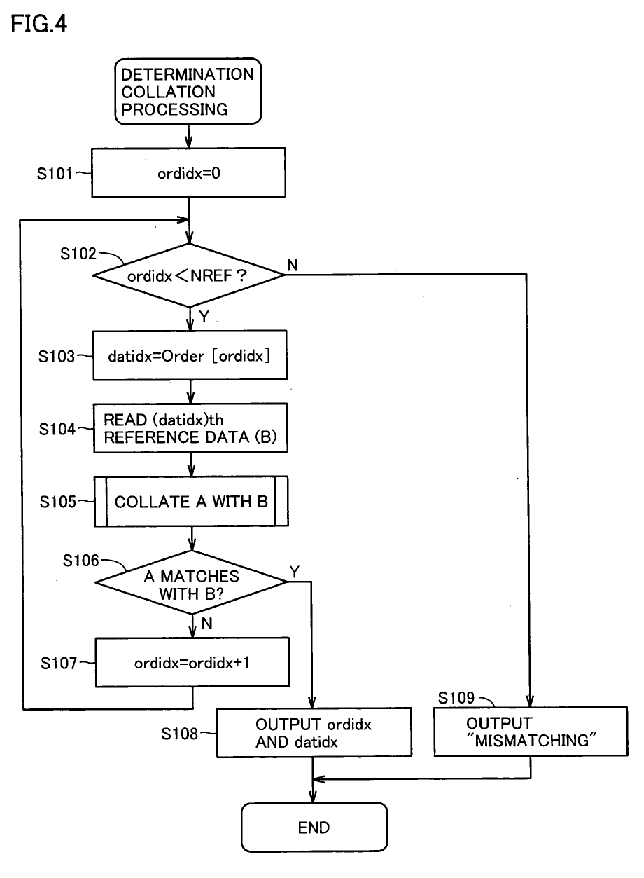

Then, collation determining unit 107 performs collation determination on collation target data A subjected to the data correction processing by data correcting unit 104 and the reference data registered in advance in reference memory 1021 (step T3). The collation determination processing will be described later with reference to FIG. 4.

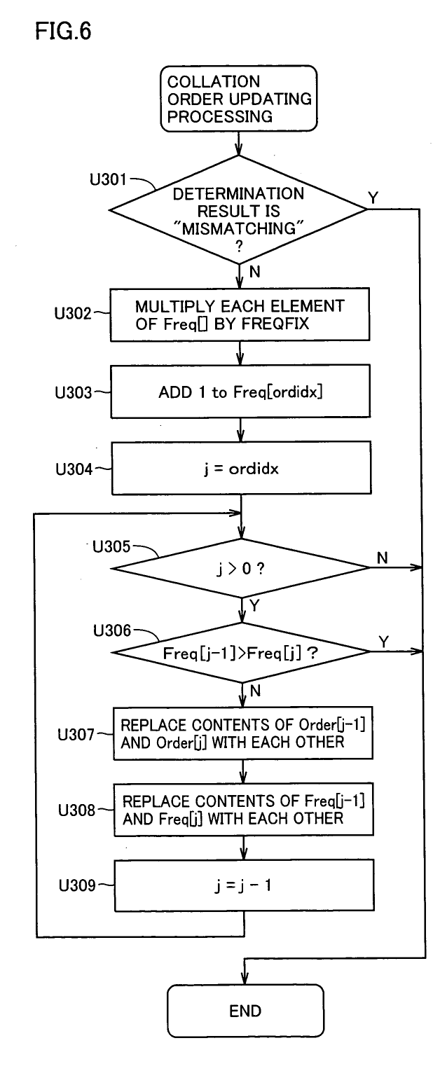

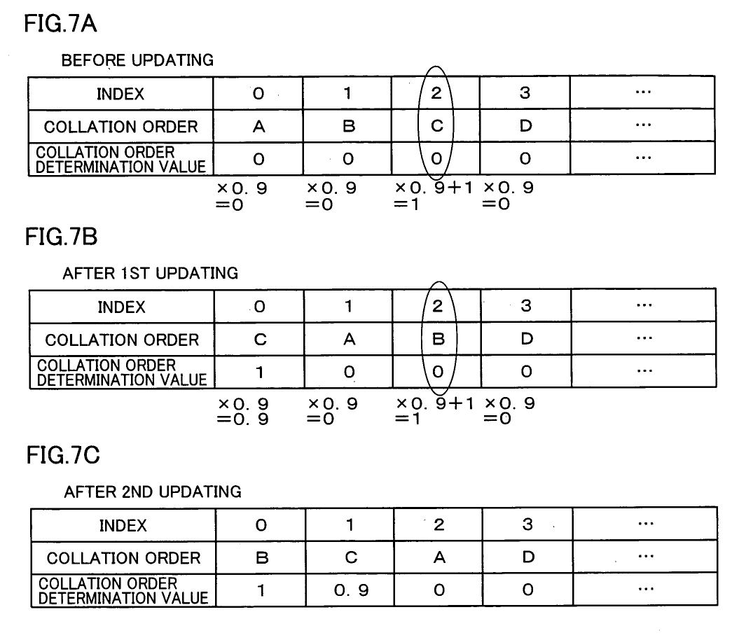

Collation processing unit 11 performs the collation order updating processing (step T4). This processing updates the collation order table (see FIGS. 7A and 7B) stored in collation order storing unit 1024 based on the result of the collation determination in step T3. The collation order updating processing will be described later with reference to FIG. 6.

Finally, control unit 108 outputs the result of the collation determination stored in memory 102 via display 610 or printer 690 (step T5). Thereby, the collation processing 1 ends.

Referring to FIG. 4, the collation determination processing will now be described. The collation determination processing is a subroutine executed in step T3 in FIG. 3. In the following description, elements in the collation order table, which stores the reference data and data including a reference order thereof, are expressed such that a first element is Order[0], and a next element is Order[1].

Prior to the collation determination processing, control unit 108 transmits a collation determination start signal to collation determining unit 107, and waits for reception of a collation determination end signal.

In step S101, index ordidx of the element in the collation order table is initialized to 0 (first and thus 0th element).

In step S102, index ordidx of the element in the collation order table is compared with NREF, which is data representing the number of reference data stored in reference memory 1021. When index ordidx of the element in the collation order table is smaller than the number NREF of the reference data, the flow proceeds to step S103.

In step S103, Order[ordidx] is read from collation order storing unit 1024, and the read value is used as a value of a variable datidx.

In step S104, the reference data indicated by index datidx of the reference data is read from reference memory 1021, and the reference data thus read is used as data B.

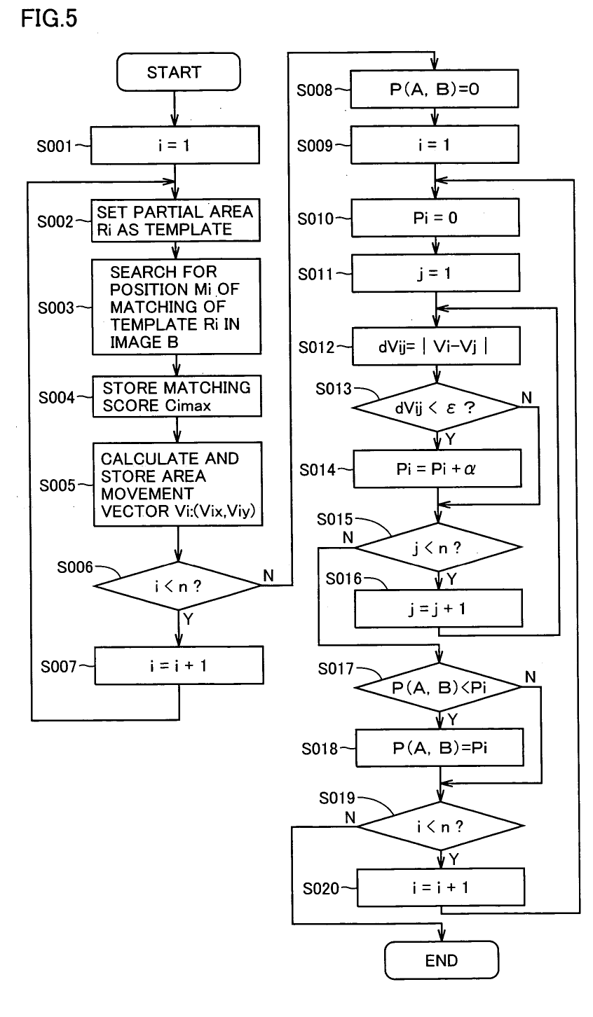

In step S105, processing is performed to collate the input data (data A) with the read reference data (data B). This processing is formed of template matching and calculation of the similarity score. Procedures of this processing are illustrated in FIG. 5. This processing will now be described in detail with reference to a flowchart of FIG. 5.

First, control unit 108 transmits a template matching start signal to maximum matching score position searching unit 105, and waits for reception of a template matching end signal. Maximum matching score position searching unit 105 starts the template matching processing as illustrated in steps S001 to S007. In step S001, a variable i of a counter is initialized to 1. In step S002, an image of a partial area, which is defined as a partial region Ri, is set as a template to be used for the template matching.

Though the partial area Ri has a rectangular shape for simplicity of calculation, the shape is not limited thereto. In step S003, processing is performed to search for a position, where data B exhibits the highest matching score with respect to the template set in step S002, i.e., the position where matching of data in the image is achieved to the highest extent. More specifically, it is assumed that partial area Ri used as the template has an image density of Ri(x, y) at coordinates (x, y) defined based on its upper left corner, and data B has an image density of B(s, t) at coordinates (s, t) defined based on its upper left corner. Also, partial area Ri has a width w and a height h, and each of pixels of data A and B has a possible maximum density of V0. In this case, a matching score Ci(s, t) at coordinates (s, t) of data B can be calculated based on density differences of respective pixels according to the following equation (1).

$$Ci ( s , t ) = {\sum }_{y = 1}^{h} {\sum }_{x = 1}^{w} ( V 0 - \vert Ri ( x , y ) - B ( s + x , t + y ) \vert ) \qquad ( 1 )$$

In data B, coordinates (s, t) are successively updated and matching score C(s, t) in coordinates (s, t) is calculated. A position having the highest value is considered as the maximum matching score position, the image of the partial area at that position is represented as partial area Mi, and the matching score at that position is represented as maximum matching score Cimax. In step S004, maximum matching score Cimax in data B for partial area Ri calculated in step S003 is stored at a prescribed address of memory 1022. In step S005, a movement vector Vi is calculated in accordance with the following equation (2), and is stored at a prescribed address of memory 1022.

As already described, processing is effected based on partial area Ri corresponding to position P set in data A, and data B is scanned to determine a partial area Mi in a position M exhibiting the highest matching score with respect to partial area Ri. A vector from position P to position M thus determined is referred to as the “movement vector”. This is because data B seems to have moved from data A as a reference, as the finger is placed in various manners on the fingerprint sensor.
Vi=(Vix, Viy)=(Mix−Rix, Miy−Riy) (2)

In the above equation (2), variables Rix and Riy are x and y coordinates of the reference position of partial area Ri, and correspond, by way of example, to the upper left corner of partial area Ri in data A. Variables Mix and Miy are x and y coordinates of the position of maximum matching score Cimax, which is the result of search of partial area Mi, and correspond, by way of example, to the upper left corner coordinates of partial area Mi located at the matched position in data B.

In step S006, it is determined whether counter variable i is smaller than a maximum value n of the index of the partial area or not. If the value of variable i is smaller than n, the process proceeds to step S007, and otherwise, the process proceeds to step S008. In step S007, 1 is added to the value of variable i. Thereafter, as long as the value of variable i is not larger than n, steps S002 to S007 are repeated. By repeating these steps, template matching is performed for each partial area Ri to calculate maximum matching score Cimax and movement vector Vi of each partial area Ri.

Maximum matching score position searching unit 105 stores maximum matching score Cimax and movement vector Vi for every partial area Ri, which are calculated successively as described above, at prescribed addresses, and thereafter transmits the template matching end signal to control unit 108. Thereby, the process proceeds to step S008.

Thereafter, control unit 108 transmits a similarity score calculation start signal to movement-vector-based similarity score calculating unit 106, and waits for reception of a similarity score calculation end signal. Movement-vector-based similarity score calculating unit 106 calculates the similarity score through the process of steps S008 to S020 of FIG. 5, using information such as movement vector Vi and maximum matching score Cimax of each partial area Ri obtained by the template matching and stored in memory 1022.

In step S008, similarity score P(A, B) is initialized to 0. Here, similarity score P(A, B) is a variable storing the degree of similarity between data A and B. In step S009, index i of movement vector Vi used as a reference is initialized to 1. In step S010, similarity score Pi related to movement vector Vi used as the reference is initialized to 0. In step S011, index j of movement vector Vj is initialized to 1. In step S012, a vector difference dVij between reference movement vector Vi and movement vector Vj is calculated in accordance with the following equation (3).
dVij=|Vi−Vj|=sqrt((Vix−Vjx)ˆ2+(Viy−Vjy)ˆ2) (3)

Here, variables Vix and Viy represent components in x and y directions of movement vector Vi, respectively, and variables Vjx and Vjy represent components in x and y directions of movement vector Vj, respectively. Variable sqrt(X) represents a square root of X, and Xˆ2 is an equation calculating a square of X.

In step S013, vector difference dVij between movement vectors Vi and Vj is compared with a prescribed constant ε, and it is determined whether movement vectors Vi and Vj can be regarded as substantially the same vectors or not. If vector difference dVij is smaller than the constant ε, movement vectors Vi and Vj are regarded as substantially the same, and the flow proceeds to step S014. If the difference is larger than the constant, the movement vectors cannot be regarded as substantially the same, and the flow proceeds to step S015. In step S014, similarity score Pi is incremented in accordance with the following equations (4) to (6).
Pi=Pi+α (4)
α=1 (5)
α=Cjmax (6)

In equation (4), variable α is a value for incrementing similarity score Pi. If α is set to 1 as represented by equation (5), similarity score Pi represents the number of partial areas that have the same movement vector as reference movement vector Vi. If α is equal to Cjmax as represented by equation (6), similarity score Pi is equal to the total sum of the maximum matching scores obtained through the template matching of partial areas that have the same movement vectors as the reference movement vector Vi. The value of variable α may be reduced depending on the magnitude of vector difference dVij.

In step S015, it is determined whether index j is smaller than the value n or not. If index j is smaller than n, the flow proceeds to step S016. Otherwise, the flow proceeds to step S017. In step S016, the value of index j is incremented by 1. By the process from step S010 to S016, similarity score Pi is calculated, using the information of partial areas determined to have the same movement vector as the reference movement vector Vi. In step S017, similarity score Pi using movement vector Vi as a reference is compared with variable P(A, B). If similarity score Pi is larger than the largest similarity score (value of variable P(A, B)) obtained by that time, the flow proceeds to step S018, and otherwise the flow proceeds to step S019.

In step S018, variable P(A, B) is set to a value of similarity score Pi using movement vector Vi as a reference. In steps S017 and S018, if similarity score Pi using movement vector Vi as a reference is larger than the maximum value of the similarity score (value of variable P(A, B)) calculated by that time using another movement vector as a reference, the reference movement vector Vi is considered to be the best reference among movement vectors Vi, which have been represented by index i.

In step S019, the value of index i of reference movement vector Vi is compared with the maximum value (value of variable n) of the indexes of partial areas. If index i is smaller than the number of partial areas, the flow proceeds to step S020, in which index i is incremented by 1. Otherwise, the flow in FIG. 5 ends.

By the processing from step S008 to step S020, similarity between image data A and B is calculated as the value of variable P(A, B). Movement-vector-based similarity score calculating unit 106 stores the value of variable P(A, B) calculated in the above described manner at a prescribed address of memory 1022, and transmits a similarity score calculation end signal to control unit 108 to end the process.

Referring to FIG. 4 again, processing in step S106 in FIG. 4 is performed to determine whether the data A and B match with each other or not, using the similarity score calculated in the collation processing in FIG. 5. Specifically, the similarity score given as a value of variable P(A, B) stored in at the prescribed address in memory 102 is compared with a predetermined collation threshold T. If the result of comparison is P(A, B)≧T, it is determined that both data A and B were obtained from the same fingerprint, and values of ordidx and datidx are written as a result of collation into a prescribed address of memory 1022 (step S108). Otherwise, 1 is added to the value of ordidx (step S107), and the processing starting from step S102 is repeated.

When it is determined in step S102 that updated ordidx is not smaller than number NREF of the reference data, this means that there is no reference data matching with input data A. In this case, a value, e.g., of “−1” representing “mismatching” is written into a prescribed address of calculation memory 1022 (step S109). Further, the collation determination end signal is transmitted to control unit 108, and the process ends.

FIG. 6 is a flowchart for illustrating the collation order updating processing, which is a subroutine executed in step T4 of FIG. 3. This processing is performed for updating the collation order table when the reference data determined as “matching” by the collation determination is present.

FIGS. 7A, 7B and 7C illustrate an example of the collation order table. In FIGS. 7A, 7B and 7C, A-D represent memory addresses at which the reference data are stored corresponding to the respective indexes. In the following description, the reference data itself stored at the respective memory addresses are referred to as the “reference data A-D”.

FIG. 7A illustrates a collation order table of the collation order before updating. FIG. 7B is the collation order table of the collation order updated one time, i.e., after first updating. FIG. 7C is the collation order table of the collation order updated two times, i.e., after second updating.

FIG. 7B illustrates an example in which the collation order place of reference data C of index 2 in the collation order table of FIG. 7A is updated to the first place in the collation order, i.e., index 0. Further, FIG. 7C illustrates an example in which the collation order place of reference data B of index 2 in the collation order table of FIG. 7B is updated to the first place in the collation order, i.e., index 0.

The collation order table includes collation order determination values determining the collation order of the respective collation data. A table representing the relationship between the collation order determination value and the collation data is referred to as the collation order determination table. Collation order storing unit 1024 has stored these collation order table and collation order determination table.

The collation order updating processing updates the collation order determination value of the reference data, which is determined as “matching” by the collation determination, by increasing it, and updates the collation order determination value of the reference data determined as “mismatching” by decreasing it so that the order of these reference data is changed according to the updated collation order values.

Referring to FIGS. 6, 7A, 7B and 7C, the flowchart of the collation order updating processing will now be described in detail. In the following description, the first element in the collation order determination table is expressed as Freq[0], and the next element is expressed as Freq[1]. For example, Freq[0] in FIG. 7A means the collation order determination value “0” of reference data A corresponding to index “0”. When biometric information collating apparatus 1 is produced (i.e., when memory 102 is initialized), the collation order determination values of the respective reference data are initialized to appropriate values (e.g., all zero).

First, in step U301, a result of collation, which is written in step S108 or S109, is read from calculation memory 1022, and it is determined whether the result of collation represents “mismatching” or not. If it represents “mismatching”, a collation order updating end signal is transmitted to control unit 108 to end the processing. If it is determined in step U301 that the result represents “matching”, the flow proceeds to step U302.

In step U302, the values of respective elements in the collation order determination table, i.e., collation order determination values Freq[0], Freq[1], Freq[2], Freq[3]. are multiplied by FREQFIX (0<FREQFIX<1), and are rewritten. FREQFIX is, e.g., “0.9”. However, FREQFIX is not limited to 0.9. For example, FREQFIX may be “0.5”. As the value of FREQFIX becomes smaller, the latest collation result is reflected in the collation order determination values, and higher priority is assigned to the latest collation result.

In step U303, a predetermined updating value is added to collation order determination value Freq[ordidx] in the collation order determination table which corresponds to index ordidx in the collation order table at the time of matching of the reference data. In connection with this, ordidx is a value which is written as the collation result into a prescribed address of calculation memory 1022 in step S108. The updating value is, e.g., “1”.

For example, when calculation memory 1022 has stored the result of collation in step U301 representing the matching of the collation target data with reference data C in FIG. 7A, the updating value is added to collation order determination value Freq[2] corresponding to reference data C of index “2”. Consequently, collation order determination value Freq[2] corresponding to reference data C of index “2” is updated from “0” to “1” in steps U302 and U303 (“0”×0.9+1=“1”).

The updating value is not restricted to “1”. Normalization may be performed such that a sum of all the collation order determination values in the collation order determination table may take a constant value, and the collation order determination value may be a stochastic value.

In step U304, the value of variable j is initialized to index ordidx in the collation order determination table appearing at the time of matching of the reference data. In other words, the value of variable j is updated to the value of ordidx which is written as a collation result into the prescribed address of calculation memory 1022 in step S108.

For example, when calculation memory 1022 has stored the collation result representing the matching of the collation target data with reference data C in FIG. 7A, the value of variable j is initialized to index “2”.

In step U305, the value of variable j is compared with 0. While j is larger than 0, the processing from step U306 to step U309 is performed. When j matches with 0, the collation order updating end signal is transmitted to control unit 108, and the processing ends. For example, when variable j is “2”, the flow proceeds to step U306.

In step U306, the value of Freq[j−1] is compared with the value of Freq[j]. If the former is larger than the latter, the collation order updating end signal is transmitted to control unit 108. Otherwise, processing in step U307 is performed.

For example, when a comparison is made between the values of Freq[2-1] and Freq[2] in FIG. 7A, the former is “0” and the latter (i.e., updated value) is “1” so that the processing in step U307 is performed.

In step U307, the values of Order[j-1] and Order[j] are replaced with each other in the collation order table. Order[j] means the reference data in the collation order table corresponding to index j. In subsequent step U308, the values of Freq[j-1] and Freq[j] are replaced with each other in the collation order determination table.

For example, the values of Order[2-1] and Order[2] are replaced with each other in FIG. 7A, and further the values of Freq[2-1] and Freq[2] are replaced with each other so that the element of index 2 is replaced with the element of index 1 in the collation order table of FIG. 7A.

In step U309, 1 is subtracted from the value of j, and the processing in and after step U305 is repeated. Consequently, in the updated collation order table, e.g., in FIG. 7A, a comparison is further made between the collation order determination value “0” of reference data A corresponding to index “0” and the collation order determination value (“1” in this case) of the reference data (reference data C in this case) corresponding to index “1”. In this case, the reference data corresponding to index “1” is data C, and the collation order determination value thereof is “1”. Therefore, the result of determination in step U306 is NO. Consequently, the values of Order[1-1] and Order[1] are replaced with each other, and the values of Freq[1-1] and Freq[1] are replaced with each other so that the collation order table is updated as illustrated in FIG. 7B.

Likewise, the collation order table is updated to reflect the latest collation determination result every time the collation order updating processing in FIG. 6 is executed after the collation determination processing. For example, when the collation determination processing is performed using the collation order table which is updated as illustrated in FIG. 7B, the collation target data may match with reference data B of index “2”, in which case the collation order table in FIG. 7B is updated as illustrated in FIG. 7C.

As described above, the collation order updating processing illustrated in FIG. 6 is executed so that the collation order table is updated to reflect the result of the latest collation determination. Therefore, it is possible to reduce on average the time required for searching for the reference data matching with the input collation target data. Consequently, the time of the collation processing can be reduced.

In this embodiment, the collation order updating processing (T4) is executed every time the collation determination processing (T3) is performed. However, the apparatus may be configured to execute the collation order updating processing every time the collation determination processing (T3) is performed several times.

The collation order updating processing updates collation order determination value D, which corresponds to the collation data determined as matching data from the result of the collation determination, by performing the arithmetic of (A·D (where 0<A<1)+B (where B>0)). Also, the collation order updating processing updates collation order determination value D, which corresponds to the collation data determined as mismatching data, by using the above A and performing the arithmetic of (A·D). For example, A is 0.9, and B is 1. A may take another value provided that (0<A<1) is satisfied. B may take another value provided that (B>0) is satisfied. As A increases, higher priority is assigned to the past collation frequency. As B increases, higher priority is assigned to the recent collation frequency.

The collation order determination value may be calculated by another operational equation. For example, it may be calculated by such a manner that a prescribed value is added to the collation order determination value corresponding to the collation data determined as matching data, and a prescribed value is subtracted from the collation order determination value corresponding to the collation data determined as mismatching data.

### Second Embodiment

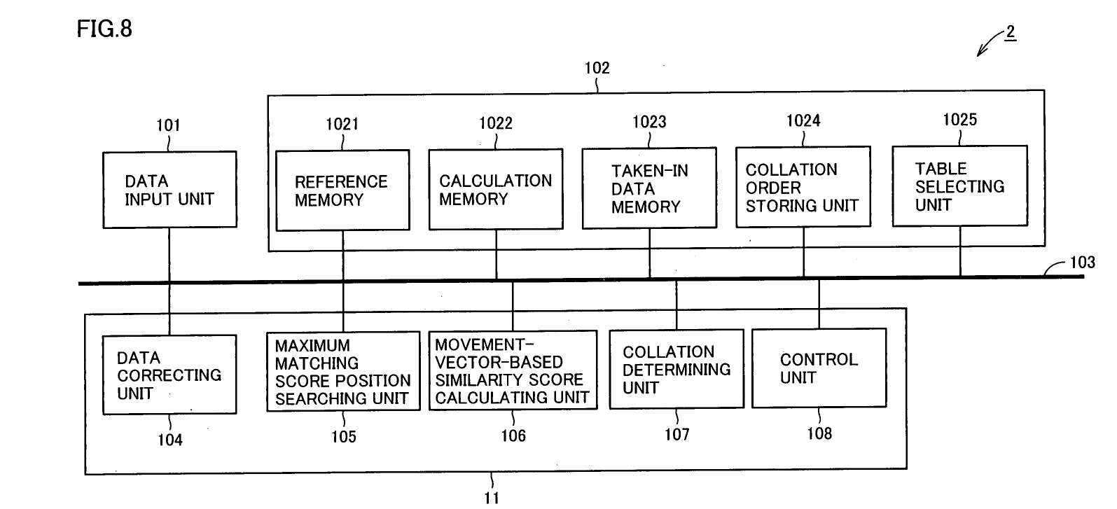

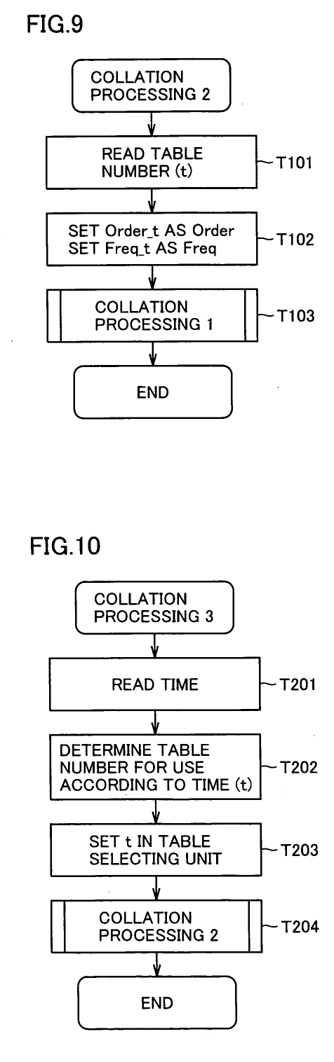

Referring to FIGS. 8 and 9, a second embodiment of the invention will now be described. FIG. 8 is a block diagram of a biometric information collating apparatus 2 according to the second embodiment. FIG. 9 is a flowchart illustrating collation processing 2 executed by biometric information collating apparatus 2.

In biometric information collating apparatus 2 according to the second embodiment, collation order storing unit 1024 of biometric information collating apparatus 1 includes a plurality of sets of the collation order tables and collation order determination table as illustrated in FIGS. 7A, 7B and 7C. In collation order storing unit 1024, it is assumed that each table is managed according to a table number t (t=0, 1, 2, 3, . . . ).

Further, memory 102 in biometric information collating apparatus 2 includes a table selecting unit 1025 holding data for selection of the collation order table and the collation order determination table to be used. Table selecting unit 1025 stores data of the table number t determining the collation order table and the collation order determination table to be used.

In the following description, the collation order table is expressed as Order_t using table number t. The collation order tables corresponding to the respective table numbers are expressed as Order_0, Order_1, Order_N. The collation order determination table is expressed as Freq_t. The collation order determination tables corresponding to the respective table numbers are expressed as Freq_0, Freq_1, Freq_N.

In biometric information collating apparatus 2, the input data and the reference data (both fingerprint images in this embodiment) are collated with each other by procedures which will now be described according to a flowchart of FIG. 9.

In first step T101, number t of the table is read from table selecting unit 1025.

In step T102, the collation order table and collation order determination table corresponding to table number t thus read are selected from collation order storing unit 1024. Selected Order_t is set as Order, and selected Freq_t is set as Freq. Thereby, one set of the collation order table and collation order determination table is selected from the plurality of sets of the collation order tables and collation order determination tables.

In step T103, collation processing 1 is executed. Collation processing 1 is already described with reference to FIG. 3. In collation processing 1, input processing of collation target data A, data correction processing, collation determination processing, collation order updating processing and result output processing are performed based on Order and Freq set in step T102.

In the second embodiment, the collation order updating processing in the first embodiment (see FIG. 6) may be employed as it is. Alternatively, the collation order updating processing may be performed by the following procedures.

These procedures differs from the procedures in FIG. 6 only in that step U302 is eliminated. According to these procedures, every time the collation determination reaches the result of “matching”, collation processing unit 11 adds a predetermined value (e.g., “1”) to the collation order determination value of the reference data determined as matching data. Consequently, the reference data are sorted in the descending order of the collation frequency in the collation order table and the collation order determination table.

### Third Embodiment

A third embodiment will now be described. The third embodiment differs from the second embodiment providing biometric information collating apparatus 2 in that the fourth embodiment further has a function of changing the collation order table and the collation order determination table used for the collation determination depending on the collation timing. In the following description, the collation order table and the collation order determination table will be collectively referred to as collation tables.

The biometric information collating apparatus according to the third embodiment includes a clock function of determining a time. The biometric information collating apparatus according to the third embodiment has the same structure as biometric information collating apparatus 2 of the second embodiment illustrated in the block diagram of FIG. 8 except for the clock function.

Table selecting unit 1025 stores the data of table number t determining the collation table to be used. The third embodiment has a table number updating function of updating the data of table number t stored in table selecting unit 1025 according to the collation timing. Collation processing unit 111 implements this table number updating function.

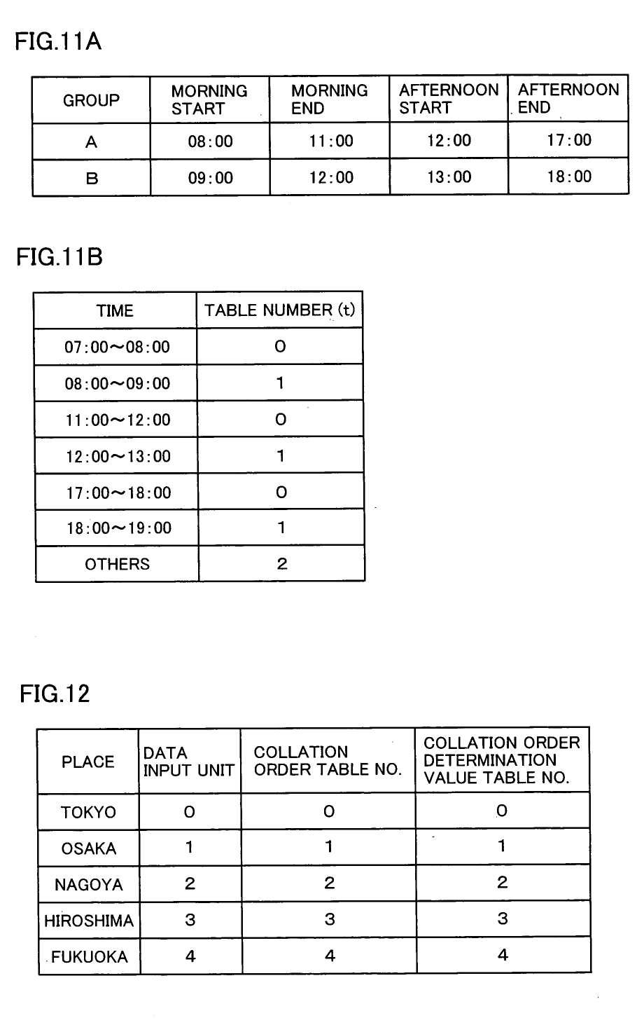

The third embodiment will now be described with reference to FIGS. 10, 11A and 11B. FIG. 10 is a flowchart illustrating collation processing 3. FIGS. 11A and 11B illustrate relationships between the collation time and the collation table. Referring to FIGS. 10, 11A and 11B, an example of selecting the table according to the time, when the collation is executed, will now be described as a specific example of changing the collation table to be used for the collation determination according to the collation timing. However, the embodiment is not limited to such example. For example, the collation table to be used may be changed according to the day of the week, the month or the season of execution of the collation.

For example, the following manner of determining the table utilizes entry/exit management corresponding to start and end of work in a place of work. The employees are divided into a plurality of groups of different work start times or work end times. FIG. 11A illustrates work start times and work end times for groups A and B. In this example, the start and end times of the employees in the groups A and B are recorded at the same place by using the biometric information collating apparatus according to the third embodiment.

For example, the work start time of the group A is 8 or 12 o'clock. The work end time of the group A is 11 or 17 o'clock. The work start time of the group B is 9 or 13 o'clock. The work end time of the group B is 12 or 18 o'clock.

Accordingly, it can be considered that the biometric data of the employees in the group A are input with high probability at about 8, 11, 12 and 17 o'clock, and the biometric data of the employees in the group B are input with high probability at about 9, 12, 13 and 18 o'clock.

For reducing the expected values of the collation time, different collation tables are used for the collation determination depending on the time period, during which many employees in the group A enter or exit, the time period, during which many employees in the group A enter or exit, and the other time period, respectively.

FIG. 11B illustrates a relationship between the respective time periods and the collation table to be used. For example, memory 102 stores the table data representing this relationship. In FIGS. 11A and 11B, the table number of the collation table corresponding to the group A is “0”, the table number of the collation table corresponding to the group B is “1”, and the table number of the collation table corresponding to the others is “2”.

The biometric information collating apparatus according to the third embodiment collates the input biometric data of the employees and the reference data (both fingerprint images in this embodiment) by the procedures which will now be described with reference to a flowchart of FIG. 10.

In step T201, a current time is read from a clock.

In step T202, table number t of the collation table to be used is determined by referring to the read time and the table of FIG. 11B.

In step T203, the table number t determined in step T202 is set in table selecting unit 1025. More specifically, the table number data in the memory corresponding to table selecting unit 1025 is updated with the value of table number t determined in step T202.

In step T204, collation processing 2 is executed. Collation processing 2 is already described with reference to FIG. 9. In collation processing 2, the apparatus reads the table number data stored in table selecting unit 1025, sets the collation table corresponding to the table number data thus read, and executes collation processing 1 illustrated in FIG. 3.

Thereby, the collation determination processing is executed using the collation table which is expected to achieve the shortest collation time in each collation period.

### Fourth Embodiment

A fourth embodiment will now be described. The fourth embodiment differs from the first embodiment providing biometric information collating apparatus 2 in that the fourth embodiment further has a function of changing the collation table to be used for the collation determination according to the place of input of the biometric data.

The biometric information collating apparatus according to the fourth embodiment includes the plurality of data input units 101 for taking in the biometric data. The biometric information collating apparatus according to the fourth embodiment is the same as biometric information collating apparatus 1 illustrated in the block diagram of FIG. 1 except for the provision of the plurality of data input units 101.

In the fourth embodiments, collation order storing unit 1024 includes a plurality of collation tables such as tables shown in FIGS. 7A, 7B and 7C, and each table is managed according to the table number t (t=0, 1, 2, 3, . . . ). Table selecting unit 1025 stores data of table number t for specifying the collation table to be used. The fourth embodiment has a table number updating function of updating the data of table number t stored in table selecting unit 1025 according to data input unit 101 through which the biometric data is input. Collation processing unit 11 implements this table number updating function.

In the system where data input units 101 for inputting the biometric data are arranged at different places, respectively, there may be a difference in people primarily using the apparatus between the places or locations of data input units 101. For example, if a corporation has a plurality of bases and has, for example, a head office in Tokyo and a branch office in Osaka, the collation frequency of each reference data varies depending on the place so that it may be efficient to use selectively the collation tables including different collation orders.

In this case, the biometric information collating apparatus according to the fourth embodiment can selectively use different collation tables depending of the place, and can efficiently perform the collation determination.

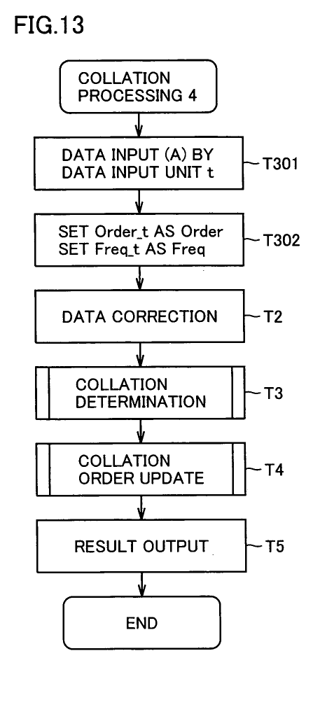

Referring to FIGS. 12 and 13, the fourth embodiment will now be described in detail. FIG. 12 illustrates a relationship of the data input units respectively arranged in different places with respect to the display numbers of the collation order table and collation order determination tables. FIG. 13 is a flowchart illustrating collation processing 4.

In the following description, the data input units are represented as data input unit 0, data input unit 1, . . . and data input unit N corresponding to the places, respectively. Also, the collation order tables and collation order determination tables are represented as Order_0, Order_1, and Order_n and as Freq_0, Freq_1, . . . and Freq_N corresponding to the places, respectively.

In the following example, data input units 0-4 are arranged in Tokyo, Osaka, Hiroshima and Fukuoka, respectively.

In first step T301, control unit 108 transmits a data input start signal to each data input unit 101, and then waits for reception of a data input end signal. One of data input units 101 takes in the data to be collated, and stores it into a prescribed address of memory 102 through bus 103.

It is assumed that data input unit t performs the above data input, and data A is input as described above. Data input unit t transmits the data input end signal to control unit 108 after the input of data A is completed.

In step T302, the collation order table and collation order determination table corresponding to t of data input unit t, which took in data A in step T301, are selected from collation order storing unit 1024. Order_t thus selected is set as Order, and Freq_t thus selected is set as Freq. Collation order storing unit 1024 stores the table data illustrated in FIG. 12. Based on this table data, the collation order table and the collation order determination table are selected in step T302.

Thereafter, the processing in steps T2-T5 is performed similarly to the first embodiment. The contents of this processing are already described with reference to FIG. 3.

Although the description has been given on the case where the one-to-one correspondence is present between the data input units and the tables, a plurality of data input units may be arranged at the same place, and may be configured to share the same table. In this case, multiple-to-one correspondence is present between the data input units and the table.

The biometric information collating apparatus already described includes, in its structure, the data input units arranged at the respective places. Although the data input unit, which is used for inputting the biometric data, forms a component of the biometric information collating system in itself, the data input unit may be a part independent of the biometric information collating apparatus. Thus, the biometric information collating apparatus is merely required to have the function of providing the biometric data from data input unit 101 to collation processing unit 11. Therefore, data input unit 101 in itself may not be an essential component of the biometric information collating apparatus.

### Fifth Embodiment

A biometric information collating apparatus according to a fifth embodiment is configured to input the biometric data through the data input units respectively arranged in a plurality of places, and to change the collation table to be used for the collation determination according to data input unit t. This configuration is the same as that of the biometric information collating apparatus according to the fourth embodiment.

The fifth embodiment differs from the fourth embodiment in that the fifth embodiment uses the collation table different from the collation table, which was used for the collation determination, when updating the collation table based on the collation result. In the following example, collation of the biometric information is performed at each of the times of entry and exit of people. FIG. 15 illustrates a relationship of the data input units respectively arranged corresponding to the entrance and exit with respect to the table numbers of the collation tables used for the collation determination and the updating. For the sake of simplicity, FIG. 15 illustrates the case in which each of the numbers of the data input units, collation order tables and collation order determination tables is equal to two (i.e., one entrance and one exit). However, the number is not restricted to two.

In the above case, if the collation determination is effected on a person having particular biometric data at an entrance, the collation determination will be effected on the same person at an exit with high probability. Likewise, if the collation determination is effected on a person having particular biometric data at the exit, the collation determination will be effected on the same person at the entrance with high probability. Therefore, the fifth embodiment proposes to update the collation order on the side opposite to that on which the collation was executed.

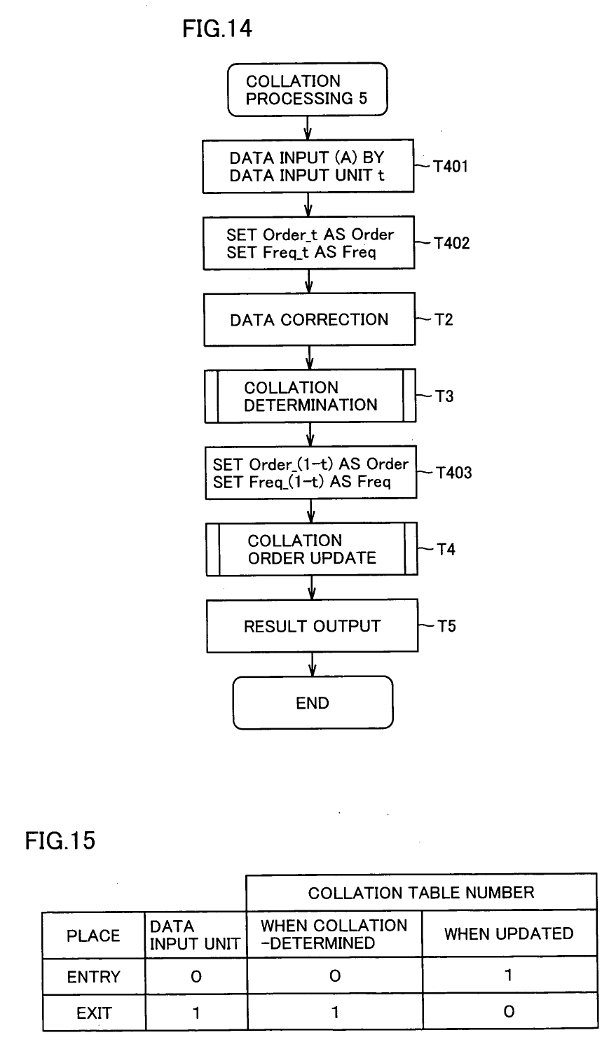

Specific procedures will now be described with reference to FIG. 14. FIG. 14 is a flowchart illustrating collation processing 5.

In a first step T401, a data input start signal is transmitted to each data input unit 101, and then waits for reception of a data input end signal. Data input unit 101 takes in data to be collated, and stores it into a prescribed address of memory 102 through bus 103. It is assumed that data input unit t performs the above data input, and data A is input as described above. Data input unit t transmits the data input end signal to control unit 108 after the input of data A is completed.

In step T402, the collation order table and collation order determination table corresponding to t of data input unit t, which took in data A in step T401, are selected from collation order storing unit 1024. Order_t thus selected is set as Order, and Freq_t thus selected is set as Freq. Collation order storing unit 1024 stores the table data illustrated in FIG. 15. Based on this table data, the collation order table and the collation order determination table are selected in step T402.

Thereafter, the processing in steps T2-T3 is performed similarly to the first embodiment to perform the collation determination on the biometric data thus input.

In step T403, the collation table, of which data is to be updated, is selected with reference to the foregoing t and the table data illustrated in FIG. 15. According to the table data in FIG. 15, Order for next use is Order_(1-t), and Freq for next use is Fre_(1-t). If t is 0, the collation table of the table number 1 is selected. If t is 1, the collation table of the table number 0 is selected. Thereby, the collation order is updated by using the table other than the table used for the collation.

Thereafter, the processing in steps T4-T5 is performed similarly to the first embodiment.

### Sixth Embodiment

The processing function for collation already described is achieved by programs. According to a third embodiment, such programs are stored on computer-readable recording medium.

In the third embodiment, the recording medium may be a memory required for processing by the computer show in FIG. 2 and, for example, may be a program medium itself such as memory 624. Also, the recording medium may be configured to be removably attached to an external storage device of the computer and to allow reading of the recorded program via the external storage device. The external storage device may be a magnetic tape device (not shown), FD drive 630 or CD-ROM drive 640. The recording medium may be a magnetic tape (not shown), FD 632 or CD-ROM 642. In any case, the program recorded on each recording medium may be configured such that CPU 622 accesses the program for execution, or may be configured as follows. The program is read from the recording medium, and is loaded onto a predetermined program storage area in FIG. 2 such as a program storage area of memory 624. The program thus loaded is read by CPU 624 for execution. The program for such loading is prestored in the computer.

The above recording medium can be separated from the computer body. A medium stationarily bearing the program may be used as such recording medium. More specifically, it is possible to employ tape mediums such as a magnetic tape and a cassette tape as well as disk mediums including magnetic disks such as FD 632 and fixed disk 626, and optical disks such as CD-ROM 642, MO (Magnetic Optical) disk, MD (Mini Disk) and DVD (Digital Versatile Disk), card mediums such as an IC card (including a memory card) and optical card, and semiconductor memories such as a mask ROM, EPROM (Erasable and Programmable ROM), EEPROM (Electrically EPROM) and flash ROM.

Since the computer in FIG. 2 has a structure, which can establish communication over communication network 300 including the Internet. Therefore, the recording medium may be configured to bear flexibly a program downloaded over communication network 300. For downloading the program over communication network 300, a program for download operation may be prestored in the computer itself, or may be preinstalled on the computer itself from another recording medium.

The form of the contents stored on the recording medium is not restricted to the program, and may be data.

According to the invention relating to the embodiments already described, the reference data is used in the collation processing in such an order that the reference data used later will be used earlier. Also, the reference data table and the order of use are changed based on the time period and place of the collation as well as states of individuals such as information of entry/exit into or from a specific building, and thereby the descending order of the probability of use is achieved so that an expected value of the processing quantity required for the collation is reduced. This effect is particularly effective in the case where the reference data is used in an unbalanced fashion. The precise biometric information collation, which is less sensitive to presence/absence of minutiae, number and clearness of images, environmental change at the time of image input, noises and others, can be performed in a short collation time with reducible power consumption. The reduction of processing is automatically performed, and this effect can be maintained without requiring the maintenance of the device.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A biometric data collating apparatus comprising:
a collation target data input unit receiving biometric collation target data;
a collation data storing unit storing a plurality of collation data used for collating the collation target data received by said collation target data input unit and priority values representing degrees of priority of collation for the respective collation data;
a collating unit reading each of the collation data stored in said collation data storing unit in a descending order of said priority, and collating the read collation data with the collation target data received by said collation target data input unit; and
a priority value updating unit updating the priority value corresponding to said collation data based on a result of the collation by said collating unit, wherein
said priority value updating unit updates the priority values such that the priority value corresponding to the collation data determined as matching data by said collating unit at a later time takes a larger value.

2. The biometric data collating apparatus according to claim 1, wherein
said priority value updating unit updates the priority value by performing arithmetic of
A·D (where 0<A<1)+B (where B>0)
on a priority value D corresponding to the collation data determined as matching data by said determining unit, and
updates the priority value by performing by performing arithmetic of A·D
using said A on the priority value D corresponding to the collation data determined as mismatching data by said collating unit.

3. The biometric data collating apparatus according to claim 2, wherein
said collation data storing unit includes a plurality of priority value tables including a first priority value table formed of the priority values respectively and individually corresponding to said plurality of collation data, and a second priority value table formed of the priority values respectively and individually corresponding to said plurality of collation data, and
said biometric data collating apparatus further comprises a selecting unit selecting the priority value table defining the priority value used by the collating unit from the plurality of priority value tables stored by said collation data storing unit.

4. The biometric data collating apparatus according to claim 3, wherein
said collation data storing unit stores a plurality of priority value tables classified according to predetermined collation times,
said biometric data collating apparatus further comprises a determining unit determining the collation time of said collation unit,
said selecting unit selects the priority value table corresponding to the collation time determined by said determining unit,
said collating unit performs the collation using the priority value table selected by said selecting unit, and
said priority value updating unit updates the priority value in the priority value table selected by said selecting unit based on the collation result of said collating unit.

5. The biometric data collating apparatus according to claim 3, wherein
said collation data storing unit stores a plurality of priority value tables classified according to input places of the collation target data,
said selecting unit selects the priority value table corresponding to the input place of the collation target data input to said collation data input unit,
said collating unit performs collation using the priority value table selected by said selecting unit, and
said priority value updating unit updates the priority values in the priority value table selected by said selecting unit based on the collation result of said collating unit.

6. The biometric data collating apparatus according to claim 3, wherein
said collation data storing unit stores two priority value tables classified for an entry place and an exit place, respectively;
when said collation target data is input from said entry place into said collation data input unit,
said selecting unit selects the priority value table for said entry place for the collation by said collating unit, and selects the priority value table for said exit place for updating by said priority value updating unit,
said collating unit performs the collation using the priority value table for said entry place selected by said selecting unit, and
said priority value updating unit updates the priority value in the priority value table for said exit place selected by said selecting unit based on the collation result of said collating unit; and
when said collation target data is input from said exit place into said collation data input unit,
said selecting unit selects the priority value table for said exit place for the collation by said collating unit, and selects the priority value table for said entry place for the updating by said priority value updating unit,
said collating unit performs the collation using the priority value table for said exit place selected by said selecting unit, and
said priority value updating unit updates the priority value of the priority value table for said entry place selected by said selecting unit based on the collation result of the collating unit.

7. The biometric data collating apparatus according to claim 3, wherein
said collation target data and said collation data are images.

8. The biometric data collating apparatus according to claim 7, wherein
said image is a fingerprint image.

9. A biometric data collating method comprising:
a collation target data input step of receiving biometric collation target data;
a collating step of reading, in a descending order of a priority of a collation data, the collation data from a collation data storing unit storing the plurality of collation data used for collating the collation target data received in the collation target data input step and said priority values representing degrees of priority of collation for the respective collation data, and collating the read collation data with the collation target data received in said collation target data input step; and
a priority value updating step of updating the priority value corresponding to said collation data based on a result of the collation in said collating step, and updating the priority value corresponding to the collation data such that the priority value corresponding to the collation data determined as matching data in the collating step at a later time takes a larger value.

10. A biometric data collating program product causing a computer to execute:
a collation target data input step of receiving biometric collation target data;
a collating step of reading, in a descending order of a priority of a collation data, the collation data from a collation data storing unit storing the plurality of collation data used for collating the collation target data received in the collation target data input step and said priority values representing degrees of priority of collation for the respective collation data, and collating the read collation data with the collation target data received in said collation target data input step; and
a priority value updating step of updating the priority value corresponding to said collation data based on a result of the collation in said collating step, and updating the priority value corresponding to the collation data such that the priority value corresponding to the collation data determined as matching data in the collating step at a later time takes a larger value.
